(19) United States
(12) Patent Application Publication
(10) Pub. No.: US 2002/0080187 A1
(43) Pub. Date: Jun. 27, 2002

(54) Enhanced method and system for category selection

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/970,160

(22) Filed: Oct. 2, 2001

Related U.S. Application Data
(60) Provisional application No. 60/237,243, filed on Oct. 2, 2000.
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,249, filed on Oct. 2, 2000.
(60) Provisional application No. 60/237,254, filed on Oct. 2, 2000.
(60) Provisional application No. 60/237,252, filed on Oct. 2, 2000.
(60) Provisional application No. 60/237,250, filed on Oct. 2, 2000.

(51) Int. Cl. G09G 5/00

(52) U.S. Cl. 345/810

(57) ABSTRACT

An enhanced method and system for viewing and selecting from multiple options for a single data element, where all options are visible and organized into subgroups, whereby the user can select or unselect any option with only a single click, no modifier key required and without affecting any other option and can quickly locate the appropriate options and determine at a glance which options are selected.

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to information retrieval from data repositories, and more particularly to an enhanced method and system for users to select one or more categories as part of search criteria.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving relevant information also increases. To locate information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). According to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, all of which support and may require searching within specific fields or columns, full-text collections which may or may not support searching within fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled). As used herein, the term “query” will be used as a synonym for the phrase “search criteria.”

According to user interface conventions for MacOS and Windows, there are standard controls that are used in certain situations. Two of the key factors in deciding which control to use are the total number of options that are directly related, and whether only one option or more than one option may be selected at once. The standard controls for these four combinations are:

(1) up to 7 options, one selection allowed: radio buttons

(2) up to 7 options, multiple selections allowed: checkboxes

(3) more than 7 options, one selection allowed: pop-up menu (MacOS) or drop-down menu (Windows)

(4) more than 7 options, multiple selections allowed: scrollable list or list box

The threshold of 7 comes from the guideline well-known among usability professionals as the “5 plus or minus 2” rule, which is a modified form of the principle articulated by psychologist George A. Miller in the 1950s with his publication The Magical Number Seven, Plus or Minus Two: Some Limits on Our Capacity For Processing Information. (The distinction between the two ranges is not significant here since the number of options discussed next easily exceed 9.)

The other key consideration in selecting a particular control is the amount of space occupied by the control. Therefore, a pop-up/drop-down menu, or, less commonly, a scrollable list, may be used when space is at a premium even if there are only a few options.

On many Web search sites that support searching within certain data elements, “Category,” “Industry” or similar is one of the primary data elements displayed on the search form. For example, the typical job search site includes well over a dozen options for the “Category” data element. As expected from the above user interface conventions, job search sites that only allow one category selection typically use a pop-up/drop-down menu control for the category, and, job search sites that allow multiple category selections typically use a scrollable list with 4-5 options visible at once.

For this number of items, the choice of a scrollable list is further reinforced by many HTML books, e.g. Chapter 17, Programming Web Pages with CGI of UNIX Unleashed, Internet Edition by Robin Burk; David B. Horvath, CCP; and Matthew Curtin (stored at http://pluto.phys.nwu.edu/˜zhaoyj/learn/Unix-internet/ch17.htm as of this writing) documents the HTML elements or tags that implement a scrollable list (“select” and “option”) as follows:

SELECT and OPTION

The SELECT and OPTION tags provide a way to define a menu of options and capture the user's selection. Although you could hard-code this functionality using checkboxes and radio buttons, the SELECT list provides a more sophisticated menu effect and saves considerable screen space if the selection list is long.

As with the INPUT TYPE=file construct, different browsers may display a SELECT menu in somewhat different ways. All will, however, provide the user with a scrollable list of options from which to choose.

[emphasis added in both cases]

However, because a scrollable list does not, either in general or in the case of the typical job search site, show all items at once, it has a number of drawbacks for use in category selection.

In order to select multiple categories, a user must generally hold a modifier key (e.g. the “control” key on Windows, the “command” key on Macintosh) to select each additional category. If the user forgets (or slips or otherwise does not hold the key while selecting each additional category), all previous selections will become unselected. Because previous selections are often scrolled out of view, the user may not realize that previous selections are no longer selected. Or, having once made the mistake, the user may as a matter of caution scroll back to at least one other selection to verify that it is still selected. In either case, the uncertainty and/or extra action can slow down data entry and increase frustration.

In many domains, including job search, there is nothing approaching a universally recognized set of categories. In practice, the categories vary widely from one job search site to another in number, in actual category name, and in meaning (i.e. it's not simply a matter of different names or terms for what are essentially the same categories). When categories are sorted alphabetically by category name, as is usually the case, the categories which are likely to be of interest to any specific user will almost always be spread throughout the list, forcing the user to scroll through the entire list in order to determine which categories are most appropriate. Most job sites limit the user to a selection of 5 or so categories, so the option of selecting anything which might possibly be appropriate is not available as a time-saving workaround. With many of the categories in the list hidden from the user at any given time, it's impossible to tell at a glance how many items have already been selected. For long lists, it takes time to scroll back through and count selections. If the user reaches the limit of how many selections are allowed before reviewing the entire list, and then finds better choices, even more time is required to scroll back and forth to decide which are the best 5 choices.

FIG. 1 illustrates a typical category list, displaying each unit of 5 separately to indicate how much scrolling is required to view all categories. FIG. 1 also illustrates sample selections for a real-world job search: a software engineer interested in high-tech contract/consulting work. The selections span most of the list, which, when viewed only 5 at a time, is considerably less manageable than when all items are visible as in the example.

These problems could be partially overcome by sizing the scrollable list such that no scrolling is required, though no known site takes this approach. This solution would require a large amount of vertical screen space, still requires that the user hold a modifier key while selecting or unselecting any item, and still requires that a user scan the entire list to find relevant categories. Beyond these problems, some site designers may either have not considered the solution or be reluctant to implement it since keeping the number of visible items under 7 or 9 appears to conform to the “5 (or 7) plus or minus 2” rule discussed above.

Some sites group the categories into a hierarchy, as shown in FIG. 2. However, according to widespread user interface convention, a scrollable list is used to group equivalent items. Therefore, breaking this convention by including two different types of items (“parent” vs. “child”) in a list is confusing. Will selecting a parent item search for just that exact category, every “child” item of the parent, or, if the parent items are intended just as labels, perhaps nothing at all? It is rarely made clear. In any case, this approach still leaves many problems, e.g. the entire list must still be scanned to see every parent category and thus to decide which one or more parent categories are most relevant.

When the user returns to a query page with a scrollable list that contains selections, whether because they made the selections earlier in the current search session or because they previously stored the query, or otherwise, the conventional implementation of a scrollable list prevents them from seeing which items are selected—except in the rare case that all of their selections happen to be at the top of the list. A few sites work around this problem by adjusting the list order (or adding additional items) to include the user's selections at the top of the list. However, that approach violates the usability principle of “perceived stability,” that is, the interface changes out from underneath the user in an unpredictable manner. (This principle is discussed, for example, on p. 11 of the Macintosh Human Interface Guidelines, copyright 1992.) It also makes the previously discussed use of hierarchy within the scrollable list even more troublesome. For example, if a “child” category was selected, should the “parent” label also be moved to the top? If not, is the category name of the “child” unambiguous when removed from the parent?

While the measured amount of wasted time and increased frustration caused by a scrollable list may be small for a given user in a single session at a single site, the time and consequent frustration can quickly add up over multiple sessions, with this total multiplied since most users visit many sites for a single purpose (e.g. searching for a job), and further multiplied when visiting other search sites (e.g. looking for an apartment or house).

Despite a very crowded field in the intensely competitive online job search market, ranging from sites that have been offering job search for at least 5 years to brand new sites, from shoestring operations to well-funded startups to divisions of major worldwide corporations, no known job site—or other search site—has solved these problems.

### SUMMARY OF THE INVENTION

In the present invention, a computer with appropriate software provides an enhanced system for selecting one or more categories, or similar data element with more than 7 options, as part of a search form or otherwise.

The present invention overcomes prior art limitations by (1) using checkboxes or other toggle controls in a situation which runs counter to conventional recommendations in two ways: the checkboxes take up more screen space, and the standard presentation would violate the “5 plus or minus 2” guideline; (2) organizing the checkboxes into labelled subgroups to bring the interface back into conformance with the “5 plus or minus 2” guideline; and (3) arranging the subgroups in a two-dimensional (2D) format for quick visual access to the subgroup headings and the items within each subgroup.

It is an object of the invention to reduce the time and frustration associated with viewing and selecting from multiple options for a single data element, by providing a method and system wherein (1) the user can select or unselect any option with only a single click, no modifier key required; (2) selecting or unselecting an option does not affect whether any other option is selected; (3) the user can see at a glance which options are selected, a feature that is especially useful when the selections come from a previously stored search; (4) with all options visible, less time and effort is required to determine which options are most appropriate; and (5) with the options organized into subgroups, locating relevant categories can be done much more quickly since entire subgroups can generally be eliminated based on the subgroup's label—and/or, having found one relevant option, the other relevant options are likely to be in the same subgroup and therefore immediately adjacent.

Other objects and advantages of the invention will, in part, be obvious, and, in part, be shown from the following description.

### BRIEF DESCRIPTION OF THE DRAWINGS

FIG. 1 depicts a typical category list in the prior art;

FIG. 2 depicts a hierarchical category list in the prior art;

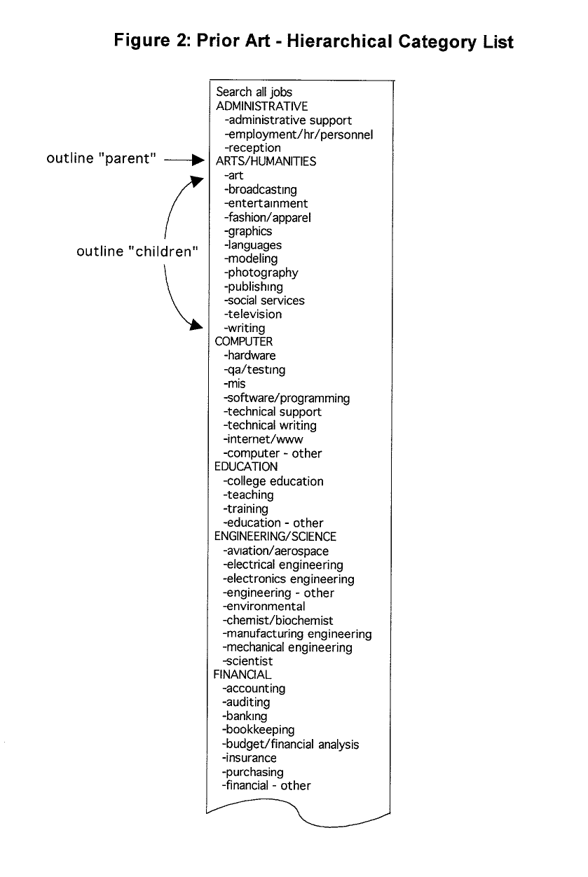

FIG. 3 depicts the components of one embodiment of the invention;

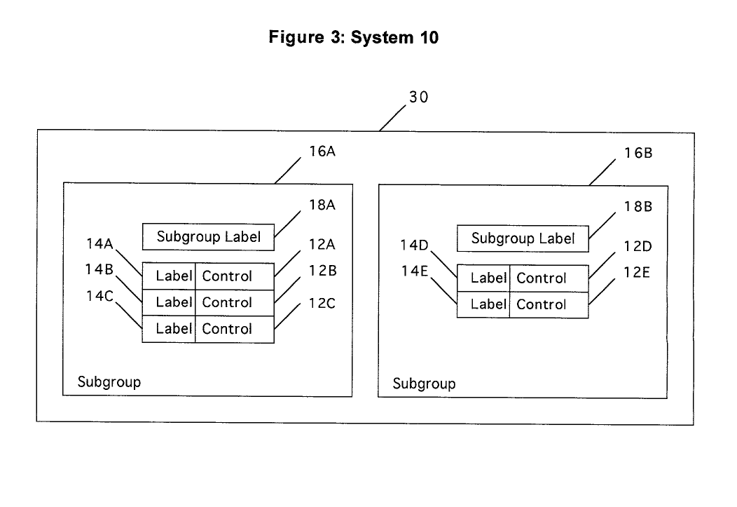

FIGS. 4a and 4b depict illustrative interfaces for category selectors according to the invention;

FIG. 5 is a flow chart depicting the steps for operating a single category control;

FIG. 6 is a schematic representation depicting one illustrative embodiment of the invention, wherein the invention is coupled to a network;

FIG. 7 is a schematic representation depicting one illustrative embodiment of the invention, wherein the invention interacts with a single electronic device.

### LIST OF REFERENCE NUMERALS

10 category selector system with components

10A-C category selectors

12A-E controls

14A-E control labels

18A-B subgroup labels

16A-B subgroups

50 system with network

52A-52C IADs

54A-54C Web browsers

56 network

58 HTTP Web server

62 search engine

64 data repository

68 server computer

90 system with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, handheld computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

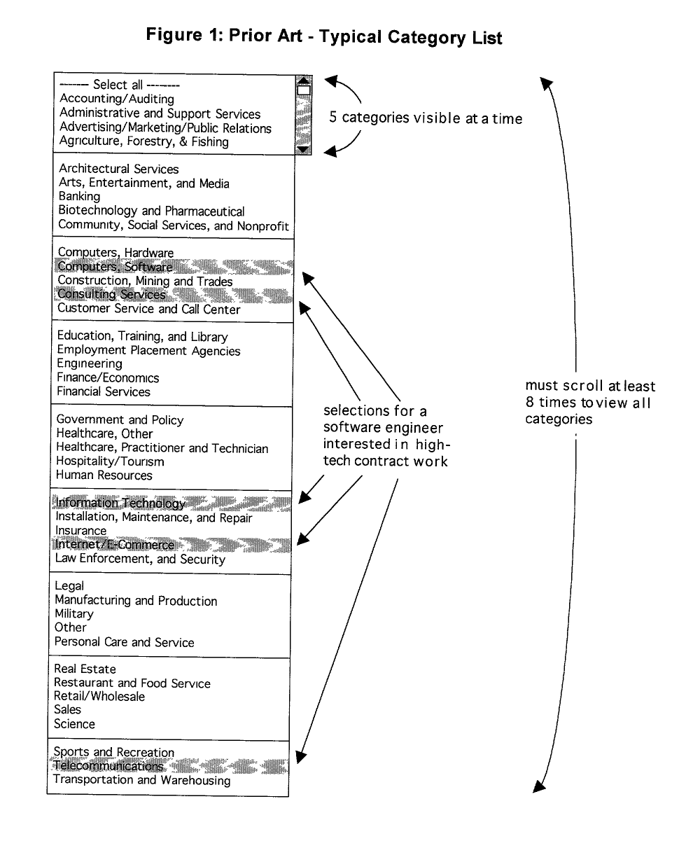

FIG. 1 depicts an illustrative embodiment of one system 10 according to the invention which simplifies category selection. The system comprises a plurality of controls 12A-E coupled with labels 14A-E, with a subset of controls 12A-E and labels 14A-E organized into a plurality of subgroups 16A-B, with each subgroup including an optional subgroup label 18A-B.

For this illustrative embodiment, the controls 12A-E, labels 14A-E, subgroups 16A-B, and subgroup labels 18A-B reside on a single computer 30 which may be a Macintosh G3 running MacOS 8.5. For this illustrative embodiment, the category selection system 10 is coded in HTML for display in a Web browser such as Netscape Communicator, Microsoft Internet Explorer, Opera or iCab.

It will be readily apparent to those skilled in the art that the computer 30 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

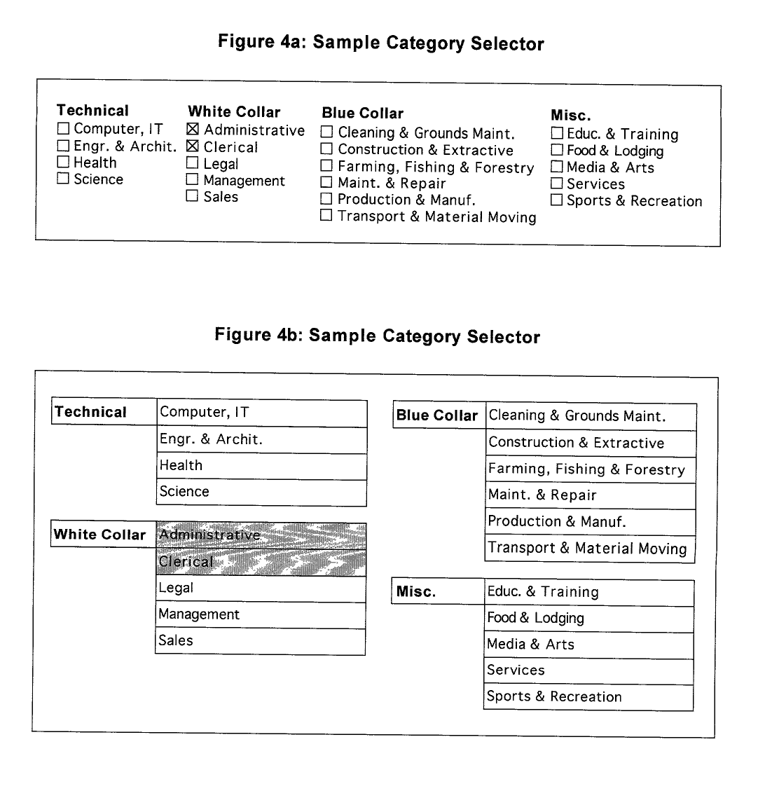

FIG. 4a depicts one illustrative embodiment of a category selector for a job search. In this embodiment, the category selector is comprised of four adjacent subgroups, labelled on the top as “Technical,” “White Collar,” “Blue Collar,” and “Misc.,” respectively. Within each subgroup is a column containing four to six checkbox controls, each followed by an adjacent label. Each checkbox control represents a single category. Two checkboxes are selected: “Administrative” and “Clerical.”

FIG. 4b depicts one illustrative embodiment of a category selector for a job search. In this embodiment, the category selector is comprised of four subgroups arranged two across and two down, labelled on the side as “Technical,” “White Collar,” “Blue Collar,” and “Misc.,” respectively. Within each subgroup is a column containing four to six toggle controls, each including an embedded label. In the unselected state, a control has a white background; in the selected state, a control has a gray background. Two controls are selected: “Administrative” and “Clerical.”

With either embodiment of the invention, users can quickly see all subgroup labels. For many job seekers, only a single subgroup will be relevant so roughly three-fourths of the individual categories can be ignored without having to consider each by itself. Even for those job seekers who start by looking at individual categories, once they find a match, other relevant categories are likely to be immediately adjacent. Selecting or deselecting any category can be done with a single mouse click, with no additional modifier key required, and no affect on which other categories are selected.

While some may initially perceive that the amount of screen space occupied by either control selector to be a drawback, the only consequence on a Web page might be one additional scrolling action to initially bring the control selector into view or to scroll on to another part of the form, if any. Compared to the numerous actions required to scroll back and forth within a scrollable list, the single action is a clear winner.

It will be readily apparent to those skilled in the art that the interface could vary in many ways, such as by putting the subgroups in a different order, swapping rows and columns, etc.

It will be readily apparent to those skilled in the art that the interface could be modified to apply to other domains, e.g. with data elements such as “Skills” to search resumes of job seekers, or “Amenities” to search apartments for rent, or “Location” to search houses for sale, etc.

It will be readily apparent to those skilled in the art that the interface could be presented in many fashions, e.g. as an XML form, a PDF form, a form implemented in a Java applet or Active X control, a form implemented using desktop or client-server software, or otherwise.

Operation

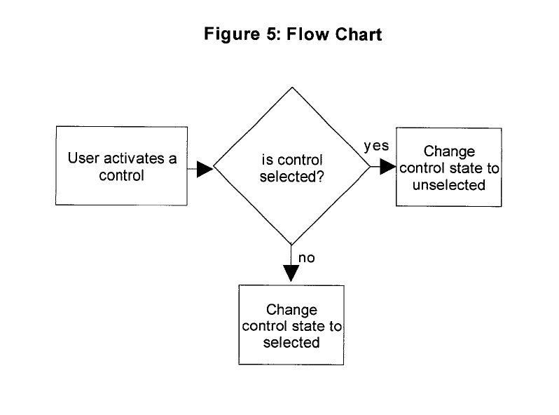

FIG. 5 is a flow chart that depicts the steps in selecting or deselecting a single control for this illustrative embodiment. Being presented with a set of controls, a user activates a control. If the control is selected, the category selection system changes the control state to unselected; otherwise to selected.

Alternative Embodiments

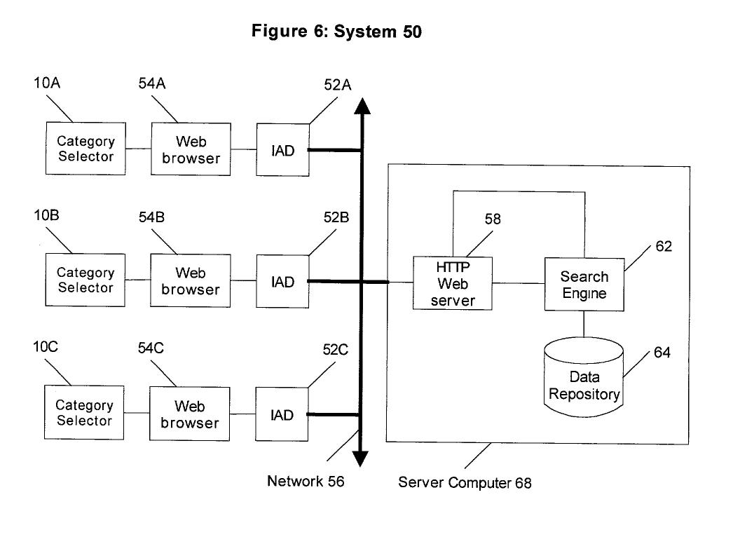

FIG. 6 depicts another illustrative embodiment of one system 50 according to the invention which simplifies category selection over a network. The system comprises a plurality of IADs 52A-52C, each integrated with or coupled to a client process such as a Web browser 54A-54C displaying category selection systems 10A-C. Each IAD is coupled to a network 56, which is in turn coupled to an HTTP Web server 58, which is coupled to search engine 62, which is in turn coupled to data repository 64, and to HTTP Web server 58 to return matching data objects to the IADs 52A-52C to display for the users on client processes such as Web browsers 54A-54C.

For this illustrative embodiment, the HTTP Web server 58, search engine 62 and data repository 64 reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that search engine 62 could interact with HTTP Web server 58 via CGI, plug-in, servlets, Enterprise Java Beans, etc.

It will be readily apparent to those skilled in the art that search engine 62 and data repository 64 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data. It will be further apparent that search engine 62 and data repository 64 need not be implemented using the same software nor even reside on the same computer.

Operation

The user controls one or more UDs to activate a control via a Web browser 54 running on an IAD 52. If the control is selected, the category selection system changes the control state to unselected; otherwise to selected. Upon completing all selections, the user activates a trigger such as a submit button, whereupon the Web browser 54 sends the selected categories and any other search criteria over the network 56 via the HTTP protocol to the HTTP Web server 58 running on the server computer 68, which forwards the request to search engine 62. Search engine 62 locates matching data in data repository 64 and sends the data objects as an HTML page to HTTP Web server 58, which returns the HTML page over the network 56 via the HTTP protocol back to the user's Web browser 54 which displays it on the VDU of IAD 52.

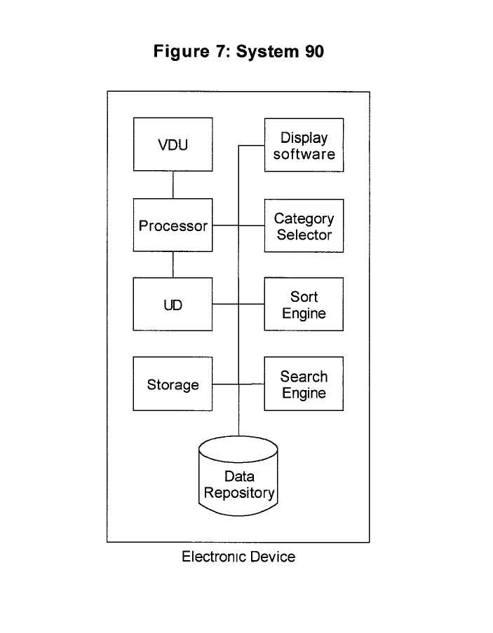

FIG. 7 depicts an illustrative embodiment of one system 90 according to the invention. The system comprises a single electronic device with at least one processor, at least one UD, at least one VDU and some form of storage, with the system 90 running software configured as one or more components to display the category selector, accept user input, perform a search on a local or embedded data repository, sort the results, and return the results to the user.

It will be readily apparent to those skilled in the art that, as depicted in FIG. 7, the category selector may have direct access to storage 20 and/or to search engine 62 and/or to data repository 64 and/or to a sort engine, reading the data from one or more locations according to the particular embodiment. It will be further apparent from FIG. 7 that search engine 62, data repository 64 and the sort engine have direct access to each other, such that any could access data on behalf of any other component according to the particular embodiment.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by providing an organized and convenient way for users to view and select categories so as to reduce the time and frustration associated with searches. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Category Selection System (CSS) responsive to a User-input Device (UD), displaying on a client process of a Visual Display Unit (VDU), the CSS comprising:
a plurality of category controls, each configured to be selected or deselected with a single user action, and without affecting whether or not the other category controls are selected;
a plurality of category labels;
a plurality of subgroup labels which identify a set of related category controls;
a controller configured to:
receive input from the UD associated with a single category control, and
if the control is selected, deselect it, otherwise select it;
whereby a user can see at a glance which subgroups and categories are available and thus more quickly locate relevant categories, and whereby a user can see at a glance which categories are currently selected, making searches faster and easier.

2. The CSS recited in claim 1 wherein the single action is a click on a mouse button, a tap on a trackpad or equivalent action.

3. The CSS recited in claim 1 wherein the single action is a key press such as on the space bar or enter key.

4. The CSS recited in claim 1 wherein every individual category control is visible when the entire CSS is visible.

5. The CSS recited in claim 1 wherein each category label is adjacent to the associated category control.

6. The CSS recited in claim 1 wherein each category label is within the bounds of the associated category control.

7. The CSS recited in claim 1 wherein the subgroups indicated by the subgroup labels are arranged in a horizontal fashion as a single row, with each subgroup occupying a single column.

8. The CSS recited in claim 1 wherein the subgroups indicated by the subgroup labels are arranged as a set of rows and columns.

9. The CSS recited in claim 1 wherein each category control is a checkbox.

10. The CSS recited in claim 1 wherein each category control is a button with a selected state and an unselected state.

11. The CSS recited in claim 1, further including a subgroup control for each subgroup, and wherein the controller is further configured to:
receive input from the UD associated with a single subgroup control, and
if the subgroup control is selected, deselect it, otherwise select it;

12. The CSS recited in claim 11 wherein the controller is further configured to:
upon input from the UD: if the subgroup control is selected, deselect it and the controls for all categories within the subgroup, otherwise select it and the controls for all categories within the subgroup;

13. The CSS recited in claim 11 wherein the subgroup control is configured with three possible states: selected, unselected, and a third state indicating that some but not all categories within the subgroup are selected.

14. The CSS recited in claim 1, further including sub-subgroup labels which identify a set of related subgroups.

15. The CSS recited in claim 1, further including:
a category input port configured to receive a list of category labels organized by subgroup, and
a selector construction mechanism configured to create the labelled category controls organized by subgroup from the list of category labels.

16. The CSS recited in claim 1 wherein the category controls employ a markup language including HTML, XML and/or SGML.

17. The CSS recited in claim 1 wherein the category controls employ a portable document format.

18. The CSS recited in claim 1 wherein the category controls employ script and/or program code.

19. The CSS recited in claim 1 wherein the category labels include employment information.

20. A search system comprising:
a CSS as recited in claim 1;
an Information Location Mechanism (ILM) coupled to a data repository containing a plurality of data objects, the ILM being configured to receive search criteria in a predetermined syntax, search the data repository, and retrieve zero or more data objects that conform to the search criteria;
a formatting engine to format the search results from the ILM; and
a client process and VDU to display the search form, the formatted search results and the action trigger.

21. The search system recited in claim 20 wherein the search form employs a markup language such as HTML, XML or SGML.

22. The search system recited in claim 20 wherein the contents of at least one data element of at least one data object include employment information.

23. The search system recited in claim 20, further including:
a sort port configured to receive sort criteria;
an Information Sorting Mechanism (ISM) coupled between the ILM and the formatting engine; the ISM being configured to receive the sort criteria in a predetermined syntax, receive a plurality of data objects from the ILM, sort the data objects according to the sort criteria, and forward the sorted data objects to the formatting engine.

24. A category selection method comprising:
displaying a plurality of category controls and associated category labels organized with subgroup labels,
receiving a single user action for a specific control,
toggling the selection state of that control without affecting the selection state of any other control;
whereby a user can see at a glance which subgroups and categories are available and thus more quickly locate relevant categories, and whereby a user can see at a glance which categories are currently selected, making searches faster and easier.
